(19) United States
(12) Patent Application Publication
(10) Pub. No.: US 2025/0074573 A1
(43) Pub. Date: Mar. 6, 2025

(54) AIRCRAFT DOOR SILL PROTECTOR

(71) Applicant: Robert George Labas, Calgary (CA)

(72) Inventor: Robert George Labas, Calgary (CA)

(21) Appl. No.: 18/238,677

(22) Filed: Aug. 28, 2023

(51) Int. Cl. B64C 1/14

(52) U.S. Cl. CPC B64C 1/1407

(57) ABSTRACT

An airplane door sill protector is provided. The sill protector is used to fit to a sill and fuselage of an airplane to prevent damage to the fuselage. The sill protector includes an elongated body having a base joined with a lip that forms a channel to receive the fuselage of the airplane door. A first and second curved section are positioned at opposing ends of the elongated body, such that each curved section arches away from a longitudinal axis and can accommodate a curved exterior edge of the airplane fuselage. The curved sections correspond to the curve of the fuselage and, in some embodiments, are extendable to fit openings of various sizes.

### BACKGROUND OF THE INVENTION

The present invention relates to an aircraft door sill protector. The present invention further provides an aircraft door sill protector that secures to a sill and fuselage of the airplane to protect this area from impact damage caused during the loading and unloading of the aircraft.

Damage to the lower section of cargo door openings, known as the sill area, and the surrounding fuselage is a recurring issue faced by airlines during the loading and unloading of heavy items into the cargo compartment. The sill plate area is critical to the aircraft's structural integrity, and even minor damage can lead to severe consequences. When damage occurs in this area, the aircraft typically faces two significant outcomes. First, the plane may be grounded immediately at its current location, leading to extensive delays and financial losses. Second, if the aircraft is permitted to fly, it must operate below altitude unpressurized, rendering it unsuitable for carrying passengers.

Additionally, flying at lower altitudes reduces fuel efficiency, which adds further operational costs. Repairing the damaged sill plate is a labor-intensive and costly process, impacting an airline's operational efficiency and budget. The alternative option of reaccommodating passengers and flight crew to a hotel or flying another aircraft with spare parts and maintenance personnel to the location further adds to the expenses, sometimes amounting to hundreds of thousands of dollars per incident. Such incidents also impact the airline's insurance costs.

Currently, there exists no suitable solution that effectively addresses the problem of protecting the aircraft's cargo door sill plate during loading and unloading operations. The lack of adequate protective measures has prompted the need for an innovative solution to prevent damage and subsequent financial and operational repercussions.

In light of the devices disclosed in the known art, it is submitted that the present invention substantially diverges in design elements and methods from the known art and consequently it is clear that there is a need in the art for an improvement for systems and methods of protecting sill plates of aircraft cargo door openings. In this regard the instant invention substantially fulfills these needs.

### SUMMARY OF THE INVENTION

In view of the foregoing disadvantages inherent in the known types of systems and methods of remedying damage to aircraft sill plates now present in the known art, the present invention provides a new system and method directed to protecting the sill and fuselage from damage.

It is an objective of the present invention to provide a sill protector that is sized to fit the sill and fuselage within a channel of the elongated body and curved sections, wherein the channel runs continuously to form a seal. The sill protector, once installed, remains secured to the aircraft during the loading and unloading of the aircraft.

It is another objective of the present invention to provide a sill protector configured to safeguard critical areas of the aircraft during loading and unloading operations. A protective cap, constructed from durable material, offers high impact resistance, ensuring that heavy items being loaded into the cargo compartment do not cause damage to the aircraft's sill and fuselage.

It is another objective of the present invention to provide a sill protector that can withstand extreme temperatures, as low as −70 degrees Celsius, without breaking or losing its efficacy.

It is another objective of the present invention to provide a sill protector that is adjustable in length that fits the contours of each aircraft's forward and aft cargo door lower sills.

It is yet another objective of the present invention to provide a sill protector that is fitted to the airplane and prevents the closure of the door when it is in place. This feature minimizes the risk of accidental damage to the sill protector.

It is an objective of the present invention to offer a cost-effective solution that can be easily adopted by airline operators to protect their entire fleet of narrow-body aircraft.

It is therefore an object of the present invention to provide a new and improved aircraft door sill plate protector that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 is a top perspective view of an aircraft door sill plate protector according to an embodiment of the present invention.

FIG. 2 is a perspective view of an aircraft with a cargo door in an open position and an embodiment of the sill protector installed to the fuselage.

FIG. 3 is a cross-sectional view of an embodiment of the aircraft door sill plate protector.

FIG. 4 is a close-up cross-sectional view of an embodiment of a curved section of an embodiment of the aircraft door sill plate protector.

FIG. 5 is a perspective view of an embodiment of the aircraft door sill plate protector mounted to the fuselage.

### DETAILED DESCRIPTION OF THE INVENTION

Reference is made herein to the attached drawings. Like reference numerals are used throughout the drawings to depict like or similar elements of the aircraft door sill plate protector. For the purpose of presenting a brief and clear description of the present invention, the embodiment discussed will be as aircraft door sill plate protector. The figures are intended for representative purposes only and should not be considered to be limiting in any respect.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

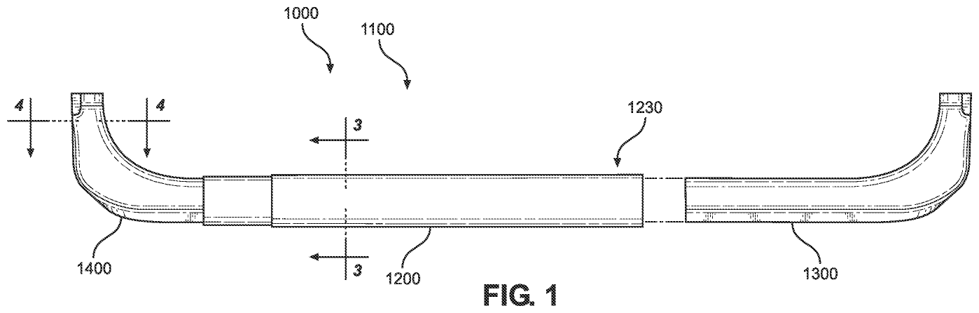

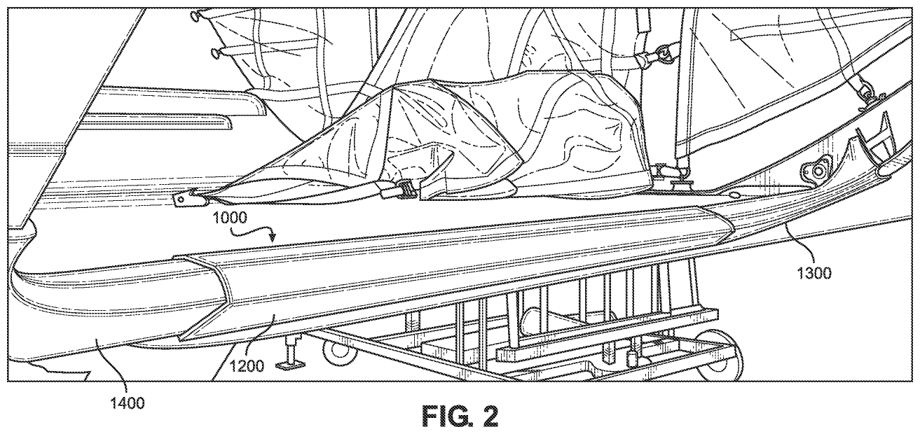

Referring now to FIGS. 1 and 2, there is shown a top perspective view of an aircraft door sill plate protector according to an embodiment of the present invention and a perspective view of an aircraft with a cargo door in an open position and an embodiment of the sill protector installed to the fuselage, respectively. The aircraft door sill plate protector 1000 comprises a protective cap 1100 that is adapted to fit to a fuselage of an airplane and the sill area when an aircraft cargo door is in an open position. In the illustrated embodiment, the aircraft door sill plate protector 1000 prevents the cargo door from closing and sealing when attached thereto. The protective cap 1000 shields the sill area from cargo, equipment, and other objects that might strike and damage the sill area during loading and loading of cargo and other aircraft operations.

An airplane “fuselage” is the main body of the aircraft that holds the crew, passengers, and cargo. The shape of the fuselage is designed to reduce aerodynamic drag and provide an efficient and streamlined structure for the aircraft to move through the air. The fuselage is often compared to a “cylinder” or a “tapered cylinder” shape, meaning that the fuselage has a circular cross-section that gradually changes in diameter along its length. In most commercial airliners, the fuselage is wider near the wings and tapers towards the tail. As for the doors, they are essentially cutouts on the fuselage that allow entry and exit for passengers and crew. These doors and door openings form complex shapes that are formed on a fuselage. These openings have complex shapes as they curve along multiple axes. The “sill area” or “sill” of an airplane refers to the lower part of the door frame/fuselage, specifically the section that is located at the entrance of the aircraft. When passengers or crew members enter or exit the airplane, they cross over the sill area. It is the threshold that separates the interior of the aircraft from the outside environment when the door is closed.

In one embodiment, the protective cap 1100 comprises an elongated body 1200 having two curved or corner sections 1300, 1400, each disposed at opposing distal ends of the elongated body 1200. The elongated body 1200 is formed from a base that joins with a lip along a front edge to form a channel. The elongated body 1200 extends along a longitudinal axis while the curved sections 1300, 1400 arch away from the longitudinal axis and are adapted to accommodate a curved exterior edge of the airplane fuselage. The channel is configured to receive the leading edge of the sill at the base of the aircraft's cargo door and is the area in need of protection during the loading and unloading of the airplane. In the shown embodiment, a first and second curved section 1300, 1400 arch away from the longitudinal axis and are adapted to accommodate a curved exterior edge of the airplane fuselage.

In one embodiment, either one or both of the first and second curved sections 1300, 1400 are removable from the elongated body 1200. In the shown embodiment, only the first curved section 1300 is removable from the elongated body 1200. The curved sections 1300, 1400 include a horizontal portion, i.e., portions positioned along the same longitudinal line as the elongated body 1200, fit in a telescoping arrangement inside respective ends of the elongated body 1200. The curved sections 1300, 1400 slide toward or away from each other based on the need to shorten or expand the protective cap 1100 to snugly fit into the cargo door lower frame including sill and corners of the fuselage. The protective cap 1100 is adapted to remain semi-permanently coupled to the sill, such that it is prevented from being loosened if struck by cargo or equipment during loading or unloading. In an alternative embodiment, the curved section 1300 and the body 1200 are otherwise joined, such as with fasteners that allow for repositioned of the curved section 1300 and the body 1200 relative to each other.

In the shown embodiment, the elongated body 1200 is slidably engaged with one of the curved sections 1300 and is adapted to transition between a retracted configuration and an extended configuration. The system 1000 may be manually and forcefully directed by a user to insert and secure the protective cap into the sill and its corners.

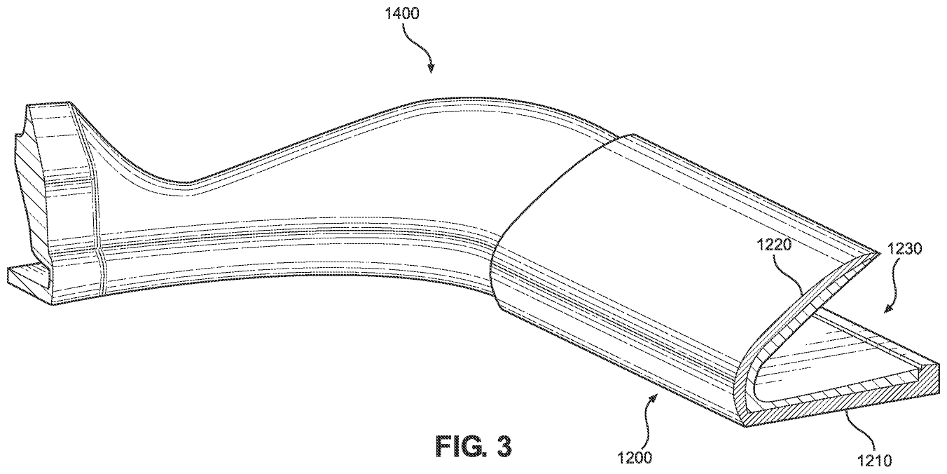

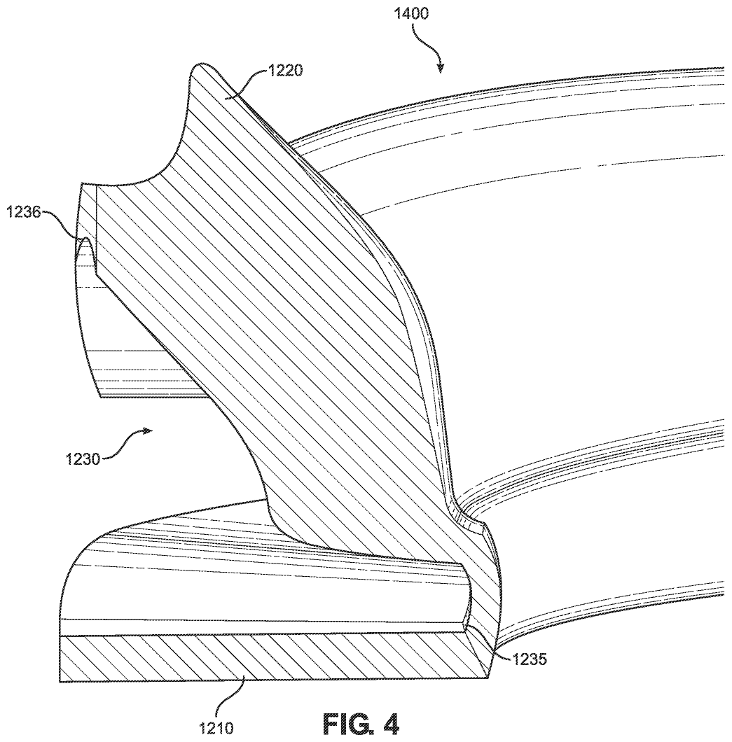

Referring specifically to FIG. 2, the protective cap 1100 is installed and firmly in place on the sill area of an aircraft cargo door in accordance with an embodiment herein. In the shown embodiment, the elongated body 1200, the first curved section 1300, and the second curved section 1300 are fitted together. The protected cap 1100 is depicted in an extended configuration to fit the sill area. During installation, the protective cap 1100 is moved to the retracted configuration and is inserted onto the floor of the sill area. Once partially received within the sill, the protective cap is transitioned to the extended configuration such that the first and second curved sections 1300, 1400 are received at the corners of the fuselage. The device is lengthened via extension of the curved sections 1300, 1400 are snugly fit the cargo door opening such that the protective cap remains in place if struck by cargo or equipment and still protects the fuselage of the aircraft. Once in the extended configuration, the sill protector 1000 remains secured to the fuselage until a user compresses the curved section with the elongated body. In one embodiment, the channel 1230 includes open ends that extend approximately ten cm from the longitudinal axis. The channel 1230 is best seen in FIGS. 3 and 4. However, in alternative embodiments, the distance of the curved sections may be longer or shorter as needed to fit the plane. In one example, one of the curved sections 1300 may be shorter and/or have a more sever curve to fit the shape of the fuselage.

In one embodiment, the aircraft door sill plate protector 1100 is specifically adapted to fit particular planes. In some airplanes, the fuselage tapers from the front of the plane to the rear of the plane, causing the shape of the fuselage to have a different dimension. In these embodiments, the curves sections 1300, 1400 have different curves and lengths that correspond to the model of the plane. In the shown embodiment, sill protector 1000 is shown to conform to a specific model of aircraft, for example the Boeing 737. In alternative embodiments, the channel 1230 is modified to accommodate other aircraft types and shapes of cargo doors.

Referring now to FIGS. 3 and 4, there is shown a cross-sectional view of an embodiment of the aircraft door sill plate protector taken along line 3-3 of FIG. 1 and a close-up cross-sectional view of an embodiment of a curved section of an embodiment of the aircraft door sill plate protector taken along line 4-4 of FIG. 1, respectively. As shown in FIG. 3, the curved section 1400 is seated within the elongated body 1200. The elongated body 1200 comprises a base 1210 and a lip 1220 that form the channel 1230 that is adapted to fit to the airplane sill. The curved section 1400 is shaped to fit against an interior side of the elongated body 1200 and be generally continuous with the rest of the elongated body 1200. In this arrangement, the curved section 1400 is in a telescopic arrangement with the elongated body 1200, such that the curved section 1400 and elongated body 1200 may be moved away from each other while the curved section 1400 remains positioned within the channel of the elongated body 1200.

In the shown embodiment, the channel 1230 is formed by the base 1210 and lip 1220 of the elongated body 1200 and continues into the structures of the curved sections 1400. While spanning three physical components, the channel 1230 is effectively a single structure from the far end of the first curved sections, across the length of the elongated body 1200, to the far end of the second curved section 1400. A single continuous seal is provided along the elongated body 1200 and curved sections 1300, 1400, thereby forming the protective for straight and corner edges of the airplane cargo door.

As shown in FIG. 4, the channel of the second curved section 1400 comprises a complex cross-section wherein the lip 1220 forms an S-shaped curve that extends from a generally horizontal base 1210. In this way, the tip 1235 of the channel 1230 is sized to receive the fuselage therein. In some embodiments, the shape of the lip 1220 allows for frictional engagement of the fuselage by bearing against the fuselage when extended thereagainst during installation. Additionally, an upper edge 1236 of the channel 1230 formed by the lip 1220 is curved from the elongated body 1200 to a distal end of the curved section 1400.

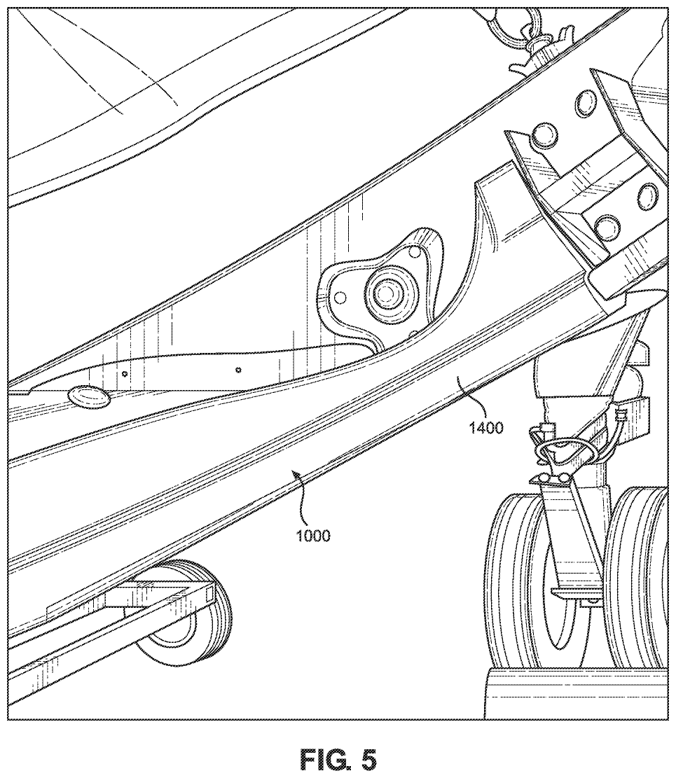

Referring now to FIG. 5, there is shown a perspective view of an embodiment of the aircraft door sill plate protector mounted to the fuselage. In the shown embodiment, the airplane door sill protector 1000 is shaped to fit to the fuselage without interfering with the hinge or other elements of the airplane door. The second curved section 1400 is tightly seated on the corner section of the fuselage such that it will remain in place in the event the protector cap is struck by cargo or equipment or stepped on by personnel. The protector 1000 is shaped to provide the channel 1230 that extends continuously from the first curved section 1300 to the second curved section 1400, including the elongated body 1200. This may alternatively be expressed as the horizontal section or elongated body having a base or lower edge joined with a lip or upper edge along a front edge or area the faces the aircraft sill. When loading, unloading, or other operation is complete, the protector 1000 may be manually removed. In some embodiments, the cargo door cannot be closed when the protector is installed.

In the shown embodiment, the airplane door sill protector 1000 comprises a semi-compressible material which is adapted to withstand strikes. In one embodiment, the semi-compressible material comprises plastic, such as urethane, or other similar substance that can withstand very cold weather. The protector may be used in many models of aircraft including various models of the Boeing 737. The protector may be provided in various configurations and sizes, some of which may fit a forward cargo door and others that may fit an aft cargo door.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An airplane door sill protector, comprising:
a protective cap configured to fit to a sill of an airplane door, the protective cap comprising:
an elongated body having a base joined with a lip along a front edge, wherein the base and lip form a channel adapted to receive the fuselage of the airplane door;
the elongated body extending along a longitudinal axis, wherein a first curved section and a second curved section are disposed at a first and second end of the elongated body, respectively;
wherein each curved section arches away from the longitudinal axis and is adapted to accommodate a curved exterior edge of the airplane fuselage;
wherein the curved sections correspond to the curve of the fuselage.

2. The airplane door sill protector of claim 1, wherein the body is in a telescoping arrangement with one of the curved sections, wherein the first body is slidably engaged with one of the curved sections to transition between a retracted configuration and an extended configuration

3. The airplane door sill protector of claim 2, wherein the retracted configuration one of the curved sections is moved towards the body such that the body is received within one of the curved sections such that the protective cap is adapted to be positioned within a width of a door opening of the fuselage.

4. The airplane door sill protector of claim 3, wherein the extended configuration one of the curved sections is moved outward from the body while remaining therein, such that lateral edges of the fuselage are seated within the curved sections of the protective cap.

5. The airplane door sill protector of claim 4, wherein the channel tapers to accommodate a variety of fuselage thicknesses.

6. The airplane door sill protector of claim 1, wherein the protective cap comprises a semi-compressible material configured to absorb impact when struck and transfer less energy to the sill.

7. The airplane door sill protector of claim 6, wherein the semi-compressible material is plastic.

8. The airplane door sill protector of claim 1, wherein the first curved section includes a curve that is greater than the curve of the second curved section.

9. The airplane door sill protector of claim 5, wherein the channel tapers towards a closed end of the channel.

10. The airplane door sill protector of claim 1, wherein the airplane door is prevented from sealing when the protective cap is installed thereon.

11. The airplane door sill protector of claim 1, wherein the protective cap is adapted to be installed on an airplane door opening.

12. The airplane door sill protector of claim 1, wherein an interior angle between the base and the lip is less than 90 degrees along the body.

13. A method of protecting an airplane door sill, comprising:
providing a protective cap configured to fit to a sill of an airplane door, the protective cap comprising:
an elongated body having a base joined with a lip along a front edge, wherein the base and lip form a channel adapted to receive the fuselage of the airplane door;
the elongated body extending along a longitudinal axis, wherein a first curved section and a second curved section are disposed at a first and second end of the elongated body, respectively;
wherein each curved section arches away from the longitudinal axis and is adapted to accommodate a curved exterior edge of the airplane fuselage;
wherein the curved sections correspond to the curve of the fuselage.
moving the protective cap to retracted configuration;
inserting the protective cap onto the floor of the sill;
moving the protective cap to an extended configuration such that the first and second curved sections are received at the corners of a fuselage;
extending one of the curved sections to allow the protective cap to fit a width of the airplane door opening:
compressing the curved section within the elongated body.
